(19) United States
(12) Patent Application Publication
(10) Pub. No.: US 2009/0155610 A1
(43) Pub. Date: Jun. 18, 2009

(54) Heat-resistant adhesive sheet

(76) Inventors: Hisayasu Kaneshiro, Kyoto (JP); Takashi Kikuchi, Shiga (JP); Takaaki Matsuwaki, Tokyo (JP)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/991,220

(22) PCT Filed: Sep. 1, 2006
(86) PCT No.: PCT/JP2006/317312

§ 371 Date: Feb. 27, 2008

(30) Foreign Application Priority Data
Sep. 5, 2005 (JP) 2005 256921

(51) Int. Cl. C09J 7/02; B32B 27/34; B32B 15/08; C09J 179/08

(52) U.S. Cl. 428/473.5

(57) ABSTRACT

It is an object of the present invention to provide a heat-resistant adhesive sheet for suppressing fluctuation in dimensional stability of a flexible printed board or, in particular, of a two-layer flexible printed board which has recently been increasingly demanded and which is required to be more highly heat-resistant and reliable. The foregoing problems can be solved by a heat-resistant adhesive sheet having a heat-resistant adhesive layer, containing a thermoplastic polyimide, which is provided on at least one surface of an insulating layer containing a non-thermoplastic polyimide, the heat-resistant adhesive sheet having a stretching of not more than 10 mm at one side thereof.

### TECHNICAL FIELD

The present invention relates to a heat-resistant adhesive sheet that suppresses fluctuation in dimensional stability of a flexible printed board or, in particular, of a two-layer flexible printed board required to be more highly heat-resistant and reliable.

### BACKGROUND ART

In recent years, as electronic products have lighter weights, smaller sizes, and higher densities, there has been an increasing demand for various printed boards. Among the printed boards, flexible laminates (also referred to, for example, as “flexible printed circuit boards (FPCs)”) have been increasingly demanded in particular. A flexible laminate is structured such that a circuit made of metal foil is formed on an insulating film.

In general, such a flexible laminate includes a substrate made of a flexible insulating film formed from various insulating materials, and is manufactured by a method for laminating metal foil onto a surface of the substrate by heating and press bonding via various adhesive materials. Preferred examples of the insulating film include a polyimide film. Commonly-used examples of the adhesive materials include thermosetting adhesives such as epoxy adhesives and acrylic adhesives (such an FPC manufactured with use of a thermosetting adhesive being hereinafter also referred to as “three-layer FPC”).

A thermosetting adhesive offers an advantage of enabling adhesion at a relatively low temperature. However, it is considered that a three-layer FPC manufactured with use of a thermosetting adhesive will have difficulty in satisfying more stringent requirements of properties such as heat resistance, bendability, and electric reliability in the future. Proposed in view of this is an FPC manufactured by providing a metal layer directly on an insulating film and by using thermoplastic polyimide as an adhesive layer (such an FPC being hereinafter also referred to as “two-layer FPC”). Such a two-layer FPC exhibits better properties than a three-layer FPC. It is expected that there will be an increasing demand for such two-layer FPCs in the future.

Meanwhile, in the technical field of electronics, there has been an increasing demand for high-density packaging. Accordingly, also in the technical field of flexible printed circuit boards (hereinafter referred to as “FPCs”), there has been an increasing demand for high-density packaging. FPC manufacturing processes are classified broadly into a step of laminating metal onto a base film and a step of forming wires on a surface of the metal. In the FPC manufacturing processes, it is during a step of etching in forming the wires on the surface of the metal and during a step of heating an FPC that the rate of dimensional change is high. It is necessary that the rate of dimensional change of an FPC be low during those steps. Furthermore, in order to achieve a higher level of high-density packaging, it is necessary to reduce fluctuation in rate of dimensional change. In cases where an FPC is manufactured with use of an adhesive sheet for use in a two-layer FPC having a thermoplastic polyimide resin used as an adhesive layer, the FPC is exposed to high temperatures in process of manufacturing the adhesive sheet. Therefore, it is more difficult to improve the dimensional stability of a two-layer FPC than to improve the dimensional stability of a three-layer FPC. Further, in particular, it is still the case that few studies have been conducted in terms of suppressing fluctuation in dimensional stability in manufacturing an FPC.

Incidentally, for the purpose of improving the flatness of a flexible printed circuit board or a cover lay film, there have been known techniques for keeping the amount of sag in a flexible printed circuit board or in an adhesive-equipped cover lay film at a specific value or below (Patent Documents 1 and 2).

Further, there have been known techniques for, by improving flatness and dimensional stability through definition of the stretching at one side of a polyimide film and the rate of thermal shrinkage of the polyimide film or by defining the maximum value of sag in a polyimide film and the rate of thermal shrinkage of the polyimide film, suppressing wrinkles and meandering that occur at the time of processing (Patent Documents 3 and 4).

However, it is for the purpose of improving the flatness of a film that these techniques define the amount of sag in the film and the stretching at one side of the film. Furthermore, these techniques make disclosures that relate to a so-called three-layer FPC manufactured with use of a thermosetting adhesive such as an epoxy adhesive.

However, the inventors made it clear that these techniques cannot be applied in the case of manufacture of a two-layer FPC that is exposed to high temperatures in a processing step. In particular, these techniques do not consider suppressing fluctuation in dimensional stability. In this light, it became clear that in the case of manufacture of a two-layer FPC, no solution is reached even by defining the amount of sag in an insulating film and the stretching at one side of the insulating film.

### [Patent Document 1] Japanese Unexamined Patent Application Publication No. 327147/1993 (Tokukaihei 5-327147)

### [Patent Document 2] Japanese Unexamined Patent Application Publication No. 139436/1996 (Tokukaihei 8-139436)

### [Patent Document 3] Japanese Unexamined Patent Application Publication No. 164006/2001 (Tokukai 2001-164006)

### [Patent Document 4] Japanese Unexamined Patent Application Publication No. 346210/2004 (Tokukai 2004-346210)

### DISCLOSURE OF THE INVENTION

### Problems to be Solved by the Invention

The present invention has been made in view of the foregoing problems, and it is an object of the present invention to suppress fluctuation in dimensional stability of a two-layer FPC that has been increasingly demanded.

### Means to Solve the Problems

The inventors diligently studied in view of the foregoing problems. As a result, the inventors found that the foregoing problems can be solved by defining the stretching at one side of a heat-resistant adhesive sheet. Thus, the inventors finally completed the present invention.

That is, the present invention can solve the foregoing problems by using the following novel adhesive sheets:

(1) A heat-resistant adhesive sheet having a heat-resistant adhesive layer, containing a thermoplastic polyimide, which is provided on at least one surface of an insulating layer containing a non-thermoplastic polyimide, the heat-resistant adhesive sheet having a stretching of not more than 10 mm at one side thereof.

(2) The heat-resistant adhesive sheet as set forth in (1), wherein the insulating layer has a ratio [E′(380° C.)/E′(250° C.)] of not more than 0.4 between storage moduli of elasticity at 250° C. and 380° C., and has a storage modulus of elasticity at 380° C. of not less than 0.7 GPa.

(3) The heat-resistant adhesive sheet as set forth in (1) or (2), wherein the insulating layer has a storage modulus of elasticity at 380° C. of not more than 2 GPa.

(4) The heat-resistant adhesive sheet as set forth in (1), wherein the non-thermoplastic polyimide resin contained in the insulating layer occupies not less than 50 wt % of the entire insulating layer.

(5) The heat-resistant adhesive sheet as set forth in (1), wherein the thermoplastic polyimide resin contained in the heat-resistant adhesive layer occupies not less than 70 wt % of the entire heat-resistant adhesive layer.

(6) A heat-resistant adhesive sheet to be continuously laminated on metal foil by heat roller lamination at a temperature of not less than 350° C., the heat-resistant adhesive sheet having a stretching of not more than 10 mm at one side thereof.

The present invention makes it possible to suppress fluctuation in rate of dimensional change that is caused in process of manufacturing a two-layer flexible metal laminate, and to increase yields while improving productivity.

### BRIEF DESCRIPTION OF DRAWINGS

FIG. 1 shows how to measure a stretching at one side.

FIG. 2 shows how to measure a rate of dimensional change.

### BEST MODE FOR CARRYING OUT THE INVENTION

An embodiment of the present invention will be described below.

(Adhesive Sheet of the Present Invention)

A heat-resistant adhesive sheet of the present invention is an adhesive sheet having a heat-resistant adhesive layer, containing a thermoplastic polyimide, which is provided on at least one surface of an insulating layer containing a non-thermoplastic polyimide, the heat-resistant adhesive sheet having a stretching of not more than 10 mm at one side thereof.

As described in “BACKGROUND ART”, it is usual to define the stretching at one side of an insulating layer and the amount of sag in the insulating layer for the purpose of improving flatness and suppressing meandering that occurs in process of manufacturing an FPC. The studies conducted by the inventors made it clear that in consideration of fluctuation in dimensional stability or, in particular, in rate of dimensional change of a two-layer FPC manufactured by using a polyimide resin both as an insulating layer and an adhesive layer, the fluctuation in rate of dimensional change of the FPC is hardly suppressed even by defining the stretching at one side of the insulating layer.

This is considered to be due to a difference in heating between a process of manufacturing a two-layer FPC and a process of manufacturing a three-layer FPC. That is, it is considered that since a three-layer FPC is manufactured with use of a thermosetting adhesive capable of being hardened at a relatively low temperature, the three-layer FPC reflects the properties of an insulting layer without being significantly affected by heating at the time of laminating metal foil.

Meanwhile, typical examples of a method for manufacturing a two-layer FPC include a method for laminating metal foil onto an adhesive sheet having a heat-resistant adhesive layer, containing a thermoplastic polyimide, which is provided on at least one surface of an insulating layer containing a non-thermoplastic polyimide film. Such a two-layer FPC needs to be heated at a high temperature in process of manufacturing the adhesive sheet. The adhesive sheet is manufactured, for example, by (i) a method for manufacturing an adhesive sheet by heating and imidizing a thermoplastic polyimide precursor applied onto a non-thermoplastic polyimide film, or by (ii) a method for coextruding, onto a support, a resin solution corresponding to the insulating layer containing the non-thermoplastic polyimide film (solution containing a non-thermoplastic polyimide precursor and an organic solvent) and a resin solution corresponding to the adhesive layer containing the thermoplastic polyimide (solution containing a thermoplastic polyimide precursor and an organic solvent), for drying the solutions on the support, for obtaining a self-supporting film, for peeling the film from the support, and for heating and imidizing the film. Regardless of what method is selected, an adhesive sheet for use in a two-layer FPC has an insulating layer containing a non-thermoplastic polyimide resin and an adhesive layer containing a thermoplastic polyimide. Therefore, in process of manufacturing the adhesive sheet, heating necessary for imidization is performed. Further, in the manufacturing process, various types of tension are applied.

The inventors made it clear that these techniques cannot be applied in the case of manufacture of a two-layer FPC. In particular, these techniques do not consider suppressing fluctuation in dimensional stability. In this light, it became clear that in the case of manufacture of a two-layer FPC, no solution is reached even by defining the amount of sag in an insulating film and the stretching at one side of the insulating film.

In view of this, fluctuation in dimensional stability is effectively suppressed by defining the stretching at one side of an adhesive sheet. In the present invention, it is preferable that the stretching at one side of an adhesive film be not more than 10 mm, more preferably not more than 9 mm, or still more preferably not more than 8 mm.

When the stretching at one side exceeds this range, there is larger fluctuation in dimensional stability. Such large fluctuation in dimensional stability tends to cause larger dimensional fluctuation in a width direction of a copper-clad laminate (FCCL).

The present invention measures a stretching at one side as follows.

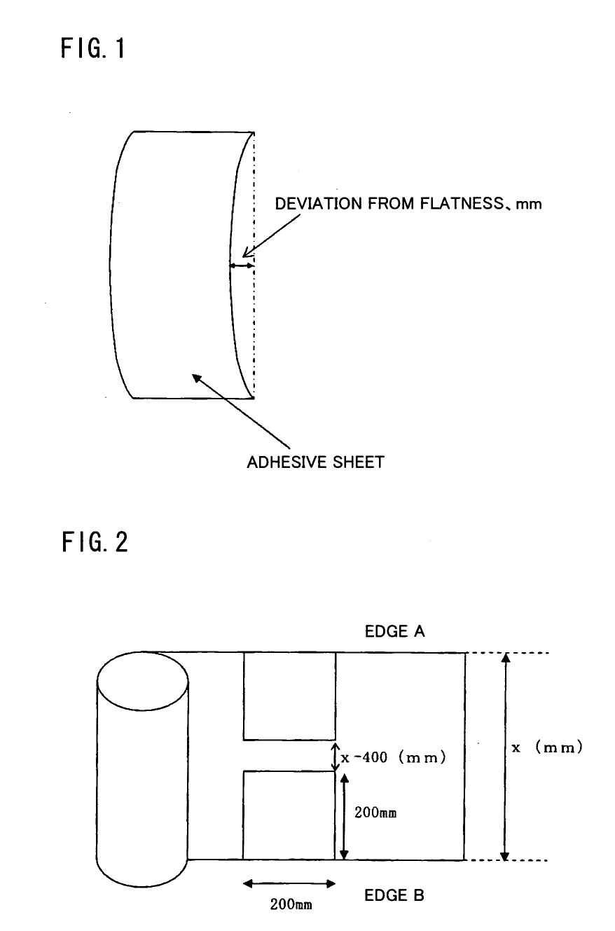

An adhesive sheet is slit so to be a strip having a width of 508 mm and a length of 6.5 m. The sheet is spread out on a flat table. Then, if the sheet is straight in a longitudinal direction, the sheet has a stretching of 0 mm at one side thereof. If the sheet is bent so as to be shaped into an arc, the sheet has a stretching at one side thereof as shown in FIG. 1. In the case of a wider adhesive sheet, the adhesive sheet is slit so as to have a width of 508 mm centered in the middle of its width direction.

In order to obtain such an adhesive film having a small stretching at one side thereof, it is important to design the thermal properties of a film for use as an insulating layer. The inventors conducted various studies on (i) the influence on the stretching at one side of a heat-resistant adhesive sheet by heat applied, as represented in the aforementioned examples, in manufacturing an adhesive sheet having a thermoplastic polyimide used as an adhesive layer and (ii) the thermal properties of an insulating layer. As a result, the inventors found that a heat-resistant adhesive layer whose stretching at one side is easily controlled is obtained by setting the ratio between storage moduli of elasticity at 250° C. and 380° C. of the insulating layer within a specific range and by setting the storage modulus of elasticity at 380° C. of the insulating layer within a specific range. That is, the influence of heat applied in process of manufacturing an adhesive sheet can be alleviated by appropriately controlling the ratio between storage moduli of elasticity of an insulating film and an absolute value at a specific temperature of the insulating layer.

First, it is preferable that the ratio [E′(380° C.)/E′(250° C.)] between storage moduli of elasticity at 250° C. and 380° C. of the insulating layer be not more than 0.4, more preferably not more than 0.35, or still more preferably not more than 0.3.

The storage modulus of elasticity at 250° C. was selected because dimensional changes in flexible copper-clad laminates after heating are often evaluated at 250° C. in the field of two-layer FPCs. The storage modulus of elasticity at 380° C. was selected because the storage modulus of elasticity is stabilized at around 380° C. Moreover, it was found that the smaller the ratio is, the smaller the stretching at one side of the adhesive sheet becomes. In particular, it is important that the ratio [E′(380° C.)/E′(250° C.)] between storage moduli of elasticity at 250° C. and 380° C. of the insulating layer be not more than 0.4. As the ratio takes on a smaller value, there is a greater difference between storage moduli of elasticity at 250° C. and 380° C. Out of this range, there is a tendency for deterioration in dimensional stability at the time of heating.

Further, it is necessary that the storage modulus of elasticity E′(380° C.) at 380° C. be not less than 0.7 GPa, or preferably not less than 0.8 GPa. Out of this range, the stretching at one side of the heat-resistant adhesive sheet becomes larger. This may cause larger fluctuation in dimensional stability.

Further, it is preferable that E′(380° C.) takes on a lower limit of not more than 2 GPa, or more preferably not more than 1.5 GPa. Out of this range, there is a tendency for deterioration in dimensional stability at the time of heating.

The storage moduli of elasticity at 250° C. and 380° C. are measured with use of a DMS-600 (manufactured by Seiko Electronics Industry Corporation) under the following conditions:

Temperature profile: 0° C. to 400° C. (3° C./min)

Sample shape: chucking interval of 20 mm, width of 9 mm

Frequency: 5 Hz

Strain amplitude: 10 μm

Minimum tension: 100

Tension gain: 1.5

Initial value of force amplitude: 100 mN

(Insulating Layer)

It is preferable that the insulating layer of the present invention be an insulating layer containing a non-thermoplastic polyimide, and that the non-thermoplastic polyimide contained in the insulating layer occupy not less than 50 wt % of the entire insulating layer. Such an insulating layer is referred to as “non-thermoplastic polyimide film”. The following describes an example of a method for manufacturing such a non-thermoplastic polyimide film.

The non-thermoplastic polyimide film for use in the present invention is manufactured by using polyamic acid as a precursor. The polyamic acid can be manufactured by any of the publicly-known methods. Usually, the polyamic acid is manufactured by dissolving substantially equimolar amounts of aromatic acid dianhydride and aromatic diamine in an organic solvent and by stirring the resulting polyamic acid organic solvent solution under controlled temperature conditions until completion of polymerization of the acid dianhydride and the diamine. Usually, such a polyamic acid solution is obtained in a concentration of 5 wt % to 35 wt %, or preferably 10 wt % to 30 wt %. In cases where the concentration falls within this range, an appropriate molecular weight and an appropriate solution viscosity are obtained.

The polymerization method can be any one of the publicly-known methods or a combination of those methods. The feature of the method for polymerizing the polyamic acid lies in the order in which the monomers are added, and the properties of the resulting polyimide can be controlled by controlling the order in which the monomers are added. Therefore, in the present invention, the polyamic acid can be polymerized by any method for adding a monomer. Typical examples of the polymerization method include the following methods:

(1) A method for performing polymerization by dissolving aromatic diamine in an organic polar solvent and by allowing the aromatic diamine to react with a substantially equimolar amount of aromatic tetracarboxylic acid dianhydride.

(2) A method for, by allowing aromatic tetracarboxylic acid dianhydride and an excessively smaller molar quantity of aromatic diamine compound to react with each other in an organic polar solvent, obtaining a prepolymer having acid anhydride groups at both terminals thereof; and then performing polymerization with use of the aromatic diamine compound so that the aromatic tetracarboxylic acid dianhydride and the aromatic diamine compound are used in substantially equimolar amounts in the entire process.

(3) A method for, by allowing aromatic tetracarboxylic acid dianhydride and an excessively smaller molar quantity of aromatic diamine compound to react with each other in an organic polar solvent, obtaining a prepolymer having amino groups at both terminals thereof; and then performing polymerization with use of the aromatic tetracarboxylic acid dianhydride after addition of an aromatic diamine compound so that the aromatic tetracarboxylic acid dianhydride and the aromatic diamine compound are used in substantially equimolar amounts in the entire process.

(4) A method for, after dissolving and/or dispersing aromatic tetracarboxylic acid dianhydride in an organic polar solvent, performing polymerization with use of an aromatic diamine compound so that the aromatic tetracarboxylic acid dianhydride and the aromatic diamine compound are in substantially equimolar amounts.

(5) A method for performing polymerization by allowing a mixture of substantially equimolar amounts of aromatic tetracarboxylic acid dianhydride and aromatic diamine to react in an organic polar solvent.

These methods may be used alone, or may be partially combined for use.

As these methods for manufacturing a polyimide film from a polyamic acid solution, conventional methods can be used. Examples of the methods include a thermal imidization method and a chemical imidization method. A film may be manufactured by either of the methods. However, imidization according to the chemical imidization method is more likely to yield a polyimide film having properties suitable for use in the present invention.

Further, a preferred process according to the present invention for manufacturing a polyimide film preferably includes the steps of:

(a) obtaining a polyamic acid solution by allowing aromatic diamine and aromatic tetracarboxylic acid dianhydride to react with each other in an organic polar solvent;

(b) flow-casting, onto a support, a film-forming dope containing the polyamic acid solution;

(c) peeling a gel film from the support after heating the film-forming dope on the support; and

(d) imidizing and drying residual amic acid by further heating.

The manufacturing process may use a hardening agent containing a dehydrating agent typified by acid anhydride such as acetic anhydride and an imidization catalyst typified by tertiary amines such as isoquinoline, β-picoline, pyridine, diethyl pyridines

The process for manufacturing a polyimide film will be described below by taking a preferred embodiment of the present invention, or a chemical imidization method, as an example. However, the present invention is not limited to the following example.

Film-forming conditions and heating conditions can vary depending on the type of polyamic acid, the film thickness, and the like.

A film-forming dope is obtained by mixing a dehydrating agent and an imidization catalyst in a polyamic acid solution at a low temperature. Subsequently, the film-forming dope is cast onto a support such as a glass plate, aluminum foil, a stainless steel endless belt, or a stainless steel drum so as to be shaped into a film. The film-forming dope is partially hardened and/or dried by activating the dehydrating agent and the imidization catalyst by heating the film-forming dope on the support within a temperature range of 80° C. to 200° C., or preferably 100° C. to 180° C. After that, a polyamic acid film (hereinafter referred to as “gel film”) is obtained by peeling the film-forming dope from the support. The gel film is in an intermediate stage during which the polyamic acid is hardened to be polyimide. The gel film has self-supporting properties. It is preferable that the gel film have a volatile content falling within a range of 5 wt % to 500 wt %, or more preferably 5 wt % to 200 wt %, or still more preferably 5 wt % to 150 wt %. The volatile content is calculated from Formula (1):

(A−B)×100/B (1)

where A is the weight of the gel film and B is the weight of the gel film as obtained after heating the gel film at 450° C. for 20 minutes. It is preferable the film be used within this range. Out of this range, there may occur such problems as breakage of the film in process of calcination, unevenness in hue of the film due to unevenness in drying, expression of anisotropy, and variations in properties.

It is preferable that the dehydrating agent be used in an amount of 0.5 mol to 5 mol, or more preferably 1.0 mol to 4 mol, with respect to unit 1 mol of amic acid contained in the polyamic acid.

It is preferable that the imidization catalyst be used in an amount of 0.05 mol to 3 mol, or more preferably 0.2 mol to 2 mol, with respect to unit 1 mol of amic acid contained in the polyamic acid.

When the dehydrating agent and the imidization catalyst fall short of those ranges, there may be breakage in process of calcination and deterioration in mechanical strength. Further, when the dehydrating agent and the imidization catalyst exceed those ranges, there may be too rapid progress in imidization. Such rapid progress in imidization makes it difficult to cast the film-forming dope into the form of a film. Therefore, it is not preferable that the dehydrating agent and the imidization catalyst exceed those ranges.

The gel film is dried with its edges fixed so that the gel film is prevented from contracting when hardened, and the gel film is rid of water, the residual solvent, the residual additive, and the catalyst. Then, the residual amic acid is completely imidized. Thus, a polyimide film of the present invention is obtained.

At this time, it is preferable that the film be finally heated at a temperature of 400° C. to 550° C. for 5 to 400 seconds. It is preferable that the film be finally calcinated at a temperature of 400° C. to 500° C., or more preferably 400° C. to 480° C. When the temperature is too low, there tends to be a negative effect on chemical resistance, moisture resistance, and mechanical strength. When the temperature is too high, there may be an increase in stretching at one side of the resulting adhesive sheet.

Further, in order to alleviate internal stress remaining in the film, the film may be treated with heat under minimal tension when conveyed. The heat treatment may be performed in process of manufacturing the film, or may be performed as a separate step. Heating conditions vary depending on the properties of the film and the type of apparatus being used, and therefore cannot be categorically described. However, in general, the internal stress can be alleviated and the rate of thermal shrinkage at 200° C. can be reduced, both by performing heat treatment at a temperature of not less than 200° C. to not more than 500° C., preferably not less than 250° C. to not more than 500° C., or more preferably not less than 300° C. to not more than 450° C., for 1 to 300 seconds, more preferably 2 to 250 second, or more preferably 5 to 200 seconds. Further, before and after the gel film is fixed, the film can be stretched to the extent that the anisotropy of the film is not aggravated. At this time, it is preferable that the volatile content fall within a range of 100 wt % to 500 wt %, or more preferably 150 wt % to 500 wt %. When the volatile content falls short of this range, the film tends to become hard to be stretched. When the volatile content exceeds this range, the self-supporting properties of the film tend to deteriorate. This may make it difficult to perform a stretching operation.

The stretching may be performed by using any publicly-known method such as a method using a differential roller or a method for widening the gripping gap of a tenter.

What is important in the present invention is the design of the non-thermoplastic polyimide film serving as the insulating layer. Any acid dianhydride or diamine component can be used as raw material as long as it yields a film having the desired storage modulus of elasticity.

Appropriately usable examples of the acid anhydride include any acid anhydride such as pyromellitic acid dianhydride, 2,3,6,7-naphthalene tetracarboxylic acid dianhydride, 3,3′,4,4′-biphenyl tetracarboxylic acid dianhydride, 1,2,5,6-naphthalene tetracarboxylic acid dianhydride, 2,2′,3,3′-biphenyl tetracarboxylic acid dianhydride, 3,3′,4,4′-benzophenone tetracarboxylic acid dianhydride, 2,2-bis(3,4-dicarboxyphenyl)propane dianhydride, 3,4,9,10-perylene tetracarboxylic acid dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)ethane dianhydride, oxydiphthalic acid dianhydride, bis(3,4-dicarboxyphenyl)sulfonic dianhydride, p-phenylene bis(trimellitic acid monoester anhydride), ethylene bis(trimellitic acid monoester anhydride), bisphenol A bis(trimellitic acid monoester anhydride), and compounds similar thereto. These anhydrides may be used alone, or may be mixed at a given ratio.

Examples of the diamine that can be appropriately used in the present invention include p-phenylenediamine, 4,4′-diaminodiphenylpropane, 4,4′-diaminodiphenylmethane, benzidine, 3,3′-dichlorobenzidine, 4,4′-diaminodiphenylsulfide, 3,3′-diaminodiphenylsulfone, 4,4′-diaminodiphenylsulfone, 4,4′-diaminodiphenylether, 3,3′-diaminodiphenylether, 3,4′-diaminodiphenylether, 1,5-diaminonaphthalene, 4,4′-diaminodiphenyldiethylsilane, 4,4′-diaminodiphenylsilane, 4,4′-diaminodiphenylethylphosphine oxide, 4,4′-diaminodiphenyl N-methylamine, 4,4′-diaminodiphenyl N-phenylamine, 1,4-diaminobenzene (p-phenylenediamine), 1,3-diaminobenzene, 1,2-diaminobenzene, 2,2-bis(4-(4-aminophenoxy)phenyl) propane, and compounds similar thereto.

As described above, the present invention is not expressed unambiguously by the molecular structure of the resin constituting the film or the method for manufacturing the film, and counts on the design of the film design of the insulating layer. Accordingly, it is only necessary that the insulating layer be able to be set to have an appropriate ratio [E′(380° C.)/E′(250° C.)] between storage moduli of elasticity at 250° C. and 380° C., and to have an appropriate storage modulus of elasticity at 380° C. Therefore, there is no complete principle for obtaining such a film, and a person skilled in the art is required to undergo a process of trial and error within the bounds of common sense in accordance with the following tendencies:

(1) E′(380° C.)/E′(250° C.) and E′(380° C.) tend to take on larger values in the case of use of a rigidly-structured monomer, such as diamines, each of which has a rigid structure represented by General Formula (1), or pyromellitic acid dianhydride:

NH₂—R₂—NH₂ General Formula (1)

(where R₂ is a group selected from the group consisting of bivalent aromatic groups represented by

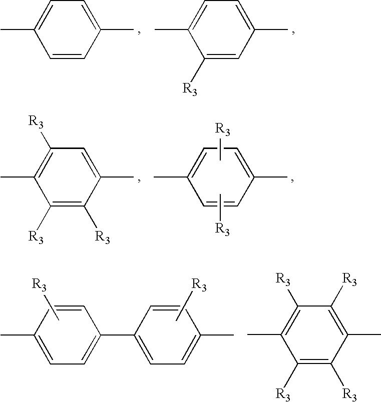

where R₃s are each independently a group selected from the group consisting of CH₃—, —OH, —CF₃, —SO₄, —COOH, —CO—NH₂, Cl—, Br—, F—, and CH₃O—).

(2) E′(380° C.)/E′(250° C.) and E′(380° C.) tend to take on smaller values in the case of use of a flexibly-structured monomer, such as diamines, which has a structure represented by General Formula (2):

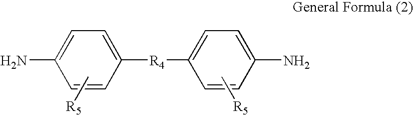

(where R₄ is a group selected from the group consisting of bivalent organic groups represented by

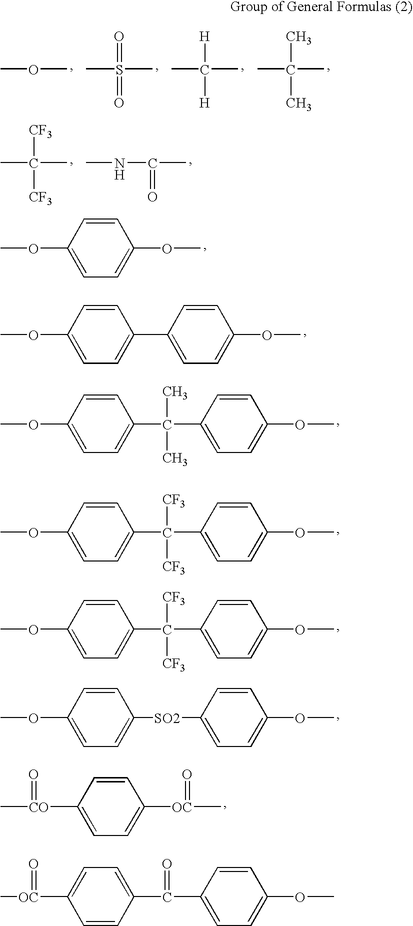

and R₅s are each independently is a group selected from the group consisting of CH₃—, —OH, —CF₃, —SO₄, —COOH, —CO—NH₂, Cl—, Br—, F—, and CH₃O—).

(3) The same tendency as in (2) applies also in the case of use of a monomer, such as 3,3′,4,4′-biphenyl tetracarboxylic acid dianhydride, which is nonlinear when seen as a molecule in its entirety.

(4) E′(380° C.)/E′(250° C.) and E′(380° C.) vary depending on how the polyamic acid serving as the polyimide precursor is polymerized. Therefore, E′(380° C.)/E′(250° C.) and E′(380° C.) may be adjusted by trying different polymerization methods by selecting or combining the aforementioned polymerization methods.

In the case of manufacture of an adhesive sheet by a method, such as coextrusion, for collectively laminating an insulating layer and an adhesive layer, it is only necessary to select a desired insulating layer by preparing only an insulating layer under the same conditions and by measuring the storage modulus of elasticity of the insulating layer.

The polyimide precursor (hereinafter referred to as “polyamic acid”) can be synthesized with use of any solvent in which the polyamic acid is dissolved. Preferred examples of such a solvent include amide solvents such as N,N-dimethylformamide, N,N-dimethylacetoamide, and N-methyl-2-pyrrolidone. Among them, N,N-dimethylformamide and N,N-dimethylacetoamide can be particularly preferably used.

Further, a filler may be added for the purpose of improving such properties of the film as slidability, thermal conductivity, electrical conductivity, corona resistance, and loop stiffness. Any filler may be used. However, preferred examples of the filler include silica, titanium oxide, alumina, silicon nitride, boron nitride, calcium hydrogen phosphate, calcium phosphate, and mica.

The particle diameter of the filler is determined by those properties of the film which are to be improved and the type of filler that is added, and therefore is not particularly limited. However, in general, it is preferable that the filler have an average particle diameter falling within a range of 0.05 μm to 100 μm, more preferably 0.1 μm to 75 μm, still more preferably 0.1 μm to 50 μm, or even more preferably 0.1 μm to 25 μm. When the particle diameter falls short of this range, there is no remarkable improvement effect. When the particle diameter exceeds this range, there is a possibility of greatly impairing surface properties or causing great deterioration in mechanical properties. Further, the number of parts by which the filler is to be added is also determined by those properties of the film which are to be improved and the particle diameter of the filler, and therefore is not particularly limited. In general, it is preferable that the amount by which the filler is to be added fall within a range of 0.01 to 100 parts by weight, more preferably 0.01 to 90 parts by weight, or still more preferably 0.02 to 80 parts by weight, with respect to 100 parts by weight of polyimide. When the amount by which the filler is to be added falls short of this range, there is no remarkable improvement effect. When the amount by which the filler is to be added exceeds this range, there is a possibility of greatly impairing surface properties or causing great deterioration in mechanical properties. The filler may be added by any method such as follows:

(1) A method for adding a filler to a polymerization reaction liquid before or during polymerization.

(2) A method for kneading a filler, for example, with use of a three-roll after completion of polymerization.

(3) A method for preparing a filler-containing dispersion liquid, and for mixing the filler-containing dispersion liquid into a polyamic acid organic solvent solution.

However, the method for mixing a filler-containing dispersion liquid into a polyamic acid organic solvent solution or, in particular, the method for mixing a filler-containing dispersion liquid into a polyamic acid organic solvent solution immediately before film formation is preferable because it minimizes contamination of a manufacturing line by the filler. In the case of preparation of a dispersion liquid containing a filler, it is preferable to use the same solvent as the solvent used in polymerizing the polyamic acid. Further, in order to satisfactorily disperse the filler in a stable dispersion state, it is possible to use a dispersing agent, a thickening agent, and the like to such an extent as not to affect the properties of the film.

(Adhesive Layer)

The thermoplastic polyimide for use as the heat-resistant adhesive layer in the present invention may be of any type that is publicly known, and the molecular weight may be controlled, for example, by a terminal blocked.

The adhesive layer may be provided on at least one surface of the insulating layer by any method such as a method for imidizing a polyamic-acid-containing adhesive layer applied onto an insulating layer or a method for coextruding an adhesive layer and an insulating layer. In the case of use of the former method, it is preferable that the glass-transition temperature be not more than 300° C., more preferably not more than 290° C., or still more preferably not more than 280° C. When the glass-transition temperature exceeds this range, the adhesive layer needs to be imidized at a high temperature. This causes the stretching at one side of the heat-resistant adhesive sheet to be likely to increase under the influence of unevenness in tension and temperature during serial production.

In order to keep the stretching at one side of the adhesive sheet within the aforementioned range, the influence of heat applied in process of manufacturing the adhesive sheet can be alleviated as described above by appropriately controlling the storage modulus of elasticity of the insulating layer. However, the stretching at one side can be affected by the temperature at which the polyimide contained in the adhesive layer is imidized.

It is preferable that the temperature be not more than 400° C., more preferably not more than 380° C., or still more preferably not more than 370° C., when measured as actual temperature with a thermocouple pasted onto the adhesive sheet. It is more preferable that the atmosphere temperature inside of a heating furnace fall within the range.

Furthermore, it is preferable that the fluctuation in atmosphere temperature in a width direction of the heating furnace fall within a range of not more than 80° C., more preferably not more than 70° C., or still more preferably not more than 60° C.

(Manufacture of an FPC)

The heat-resistant adhesive sheet thus obtained can be laminated onto a conducting layer by a publicly-known method such as heat rolling, double-belt pressing, or single-plate pressing.

It is preferable that the heating temperature in the heat laminating step, i.e., the laminating temperature be a temperature of 50° C. plus the glass-transition temperature (Tg) of the adhesive film, or more preferably Tg+100° C. In the case of Tg+50° C., it is possible to satisfactorily laminate the adhesive film and the metal foil onto each other with heat. In the case of Tg+100° C., it is possible to improve productivity by increasing the speed of lamination. Further, it is preferable that the laminating temperature be not less than 350° C.

It is preferable that the tension of the adhesive film fall within a range of 0.01 N/cm to 4 N/cm, more preferably 0.02 N/cm to 2.5 N/cm, or still more preferably 0.05 N/cm to 1.5 N/cm. When the tension falls short of the range, the adhesive film sags and meanders when conveyed for lamination, and therefore is not fed uniformly to a heating roller. This may make it difficult to obtain a flexible metal-clad laminate that is good in appearance. On the other hand, when the tension exceeds the range, the tension exerts too strong an influence to be controlled by the glass-transition temperature of the adhesive layer and the storage modulus of elasticity. This may cause deterioration in dimensional stability.

It is preferable that the fluctuation in rate of dimensional change in the case of manufacture of an FPC takes on an absolute value of not more than 0.05%, more preferably not more than 0.04%, or still more preferably not more than 0.03%.

When the fluctuation exceeds this range, there likely to occur problems at the time of packaging.

### EXAMPLES

The present invention will be fully described below by way of Examples. However, the present invention is not limited to these Examples.

(Measurement of Dynamic Viscoelasticity)

The storage moduli of elasticity at 250° C. and 380° C. were measured with use of a DMS-600 (manufactured by Seiko Electronics Industry Corporation) under the following conditions:

Temperature profile: 0° C. to 400° C. (3° C./min)

Sample shape: chucking interval of 20 mm, width of 9 mm

Frequency: 5 Hz

Strain amplitude: 10 μm

Minimum tension: 100

Tension gain: 1.5

Initial value of force amplitude: 100 mN

(Stretching at One Side)

An adhesive sheet was slit so to be a strip having a width of 508 mm and a length of 6.5 m. The sheet was spread out on a flat table. At this time, it was assumed that if the sheet is straight in a longitudinal direction, the sheet has a stretching of 0 mm at one side thereof, and that if the sheet is bent so as to be shaped into an arc, the sheet has a stretching at one side thereof as shown in FIG. 1.

(Rate of Dimensional Change of an FCCL)

A piece with the dimensions 20 cm×20 cm was cut out from the FCCL. Datum holes each having a diameter of 1 mm were made in four corners of the FCCL piece at intervals of 15 cm. Then, the copper foil was completely removed by etching. After the resulting adhesive sheet had been subjected to humidity conditioning under 55% RH at 23° C. for 24 hours, the distances between the datum holes were measured as initial values. The adhesive sheet was further treated with heat at 250° C. for 30 minutes, and then subjected to humidity conditioning under 55% RH at 23° C. for 24 hours. Then, the distances between the datum holes were measured as values after heating.

The rate of change in distances between the holes served as a rate of dimensional change during heating.

The aforementioned rate of dimensional change was measured both in an MD and TD direction.

The fluctuation in rate of dimensional change was measured in the following manner.

As shown in FIG. 2, samples for use in measurement of the rate of dimensional change were cut out from edges of an FCCL having a width of not less than 400 mm. Specifically, five samples for use in measurement of the rate of dimensional change were cut out from each of the edges A and B in a longitudinal direction. Evaluation was made in accordance with the absolute value of a difference among the average values of the five samples.

### Reference Example 1

### Synthesis of a Thermoplastic Polyimide Precursor

A polyamic acid solution having a viscosity of 2800 poise and a solid concentration of 18.5 wt % was obtained by allowing 2,2-bis[4-(4-aminophenoxy)phenyl]propane (BAPP) and 3,3′4,4′-biphenyl tetracarboxylic acid dianhydride (BPDA) to react with each other at a molar ratio of 1:1 at a warming temperature of 40° C. for 5 hours with use of DMF as a solvent.

### Example 1

Polymerization was preformed as prescribed in Table 1.

In 656 kg of N,N-dimethylformamide (DMF) cooled down to 10° C., 36.4 kg of 2,2-bis[(4-aminophenoxy)phenyl]propane (BAPP) and 10.0 kg of 3,4′-oxydianiline (3,4′-ODA) were dissolved. Then, 19.6 kg of 3,3′,4,4′-benzophenone tetracarboxylic acid dianhydride (BTDA) was added to and dissolved in the resulting solution. Then, 13.9 kg of pyromellitic acid dianhydride (PMDA) was added to the resulting solution. Then, the resulting solution was stirred for 60 minutes. In the result, a prepolymer was formed.

In this solution, 15.0 kg of p-phenylenediamine (p-PDA) was dissolved. Then, 32.0 kg of PMDA was added, and then dissolved by stirring the resulting solution for one hour. Further added carefully to this solution was a DMF solution of PMDA (weight ratio of PMDA 1.2 kg/DMF 15.6 kg) that had been separately prepared. The addition of the DMF solution of PMDA was stopped when the viscosity reached approximately 3000 poise. The resulting solution was stirred for 3 hours. In the result, a polyamic acid solution having a solid concentration of 16 wt % and a rotational viscosity at 23° C. of 3100 poise was obtained (molar ratio: BAPP/3,4′-ODA/PDA/BTDA/PMDA=32/18/50/22/78).

To this polyamic acid solution, a chemical imidization agent consisting of 20.71 kg of acetic anhydride, 3.14 kg of isoquinoline, and 26.15 kg of DMF was added at a weight ratio of 45% with respect to the polyamic acid DMF solution. The resulting solution was quickly stirred by a mixer, extruded from a T die, and flow-cast onto a stainless steel endless belt moving at 15 mm below the die. The resulting resin film was dried at 130° C. for 100 seconds, peeled from the endless belt (volatile content of 63 wt %), fixed by a tenter pin, and then dried and imidized in a tentering furnace at 250° C. (hot air) for 20 seconds, at 450° C. (hot air) for 20 seconds, and at 460° C. (combination of hot air and a far-infrared heater) for 60 seconds. In the result, a polyimide film having a thickness of 17 μm was obtained. The properties of the film are shown in Table 1.

The polyamic acid solution obtained in Reference Example 1 was diluted until the solid concentration became 10 wt %. Then, the polyamic acid was applied onto both surfaces of the polyimide film so that the final single-sided thickness of a thermoplastic polyimide layer (adhesive layer) is 2 μm. The resulting product was heated at 140° C. for one minute. Subsequently, the resulting product was imidized by heating while being passed under a tension of 3 kg/m for 20 seconds through a far-infrared heating furnace having an atmosphere temperature of 360° C. In the result, an adhesive sheet was obtained. Sheets of rolled copper foil (BHY-22B-T; manufactured by Japan Energy Corporation) each having a thickness of 18 μm were laminated with heat onto both surfaces of the adhesive sheet, and protection materials (APICAL 125NPI; manufactured by Kanegafuchi Chemical Industry Co., Ltd.) were continuously laminated with heat onto both the sheets of copper foil, both under the following conditions: a polyimide film tension of 5 N/cm; a laminating temperature of 360° C.; a laminating pressure of 196 N/cm (20 kgf/cm); and a speed of lamination of 1.5 m/minute. In the result, an FCCL was obtained. The properties of the adhesive sheet and FCCL thus obtained are shown in Table 1.

### Example 2

As in Example 1, polymerization was performed as prescribed in Table 1. In N,N-dimethylformamide (DMF) cooled down to 10° C., 2,2-bis[(4-aminophenoxy)phenyl]propane (BAPP) was dissolved. Then, 3,3′,4,4′-benzophenone tetracarboxylic acid dianhydride (BTDA) was added to and dissolved in the resulting solution. Then, pyromellitic acid dianhydride (PMDA) was added to the resulting solution. Then, the resulting solution was stirred for 60 minutes. In the result, a prepolymer was formed.

In this solution, p-phenylenediamine (p-PDA) was dissolved. Then, PMDA was added, and then dissolved by stirring the resulting solution for one hour. Further added carefully to this solution was a DMF solution of PMDA (weight ratio of PMDA 1.2 kg/DMF 15.6 kg) that had been separately prepared. The addition of the DMF solution of PMDA was stopped when the viscosity reached approximately 3000 poise. The resulting solution was stirred for 3 hours. In the result, a polyamic acid solution having a solid concentration of 16 wt % and a rotational viscosity at 23° C. of 3100 poise was obtained (molar ratio: BAPP/BPDA/PMDA/PDA=40/15/85/60).

By using this solution, a polyimide film having a thickness of 10 μm, an adhesive sheet having a thickness of 14 μm, and an FCCL were obtained in the same manner as in Example 1. Their properties are shown in Table 1.

### Comparative Example 1

As in Example 1, polymerization was performed as prescribed in Table 1. In N,N-dimethylformamide (DMF) cooled down to 10° C., 2,2-bis[(4-aminophenoxy)phenyl]propane (BAPP) was dissolved. Then, 3,3′,4,4′-benzophenone tetracarboxylic acid dianhydride (BTDA) was added to and dissolved in the resulting solution. Then, pyromellitic acid dianhydride (PMDA) was added to the resulting solution. Then, the resulting solution was stirred for 60 minutes. In the result, a prepolymer was formed.

In this solution, p-phenylenediamine (p-PDA) was dissolved. Then, PMDA was added, and then dissolved by stirring the resulting solution for one hour. Further added carefully to this solution was a DMF solution of PMDA (weight ratio of PMDA 1.2 kg/DMF 15.6 kg) that had been separately prepared. The addition of the DMF solution of PMDA was stopped when the viscosity reached approximately 3000 poise. The resulting solution was stirred for 3 hours. In the result, a polyamic acid solution having a solid concentration of 16 wt % and a rotational viscosity at 23° C. of 3100 poise was obtained (molar ratio: BAPP/BTDA/PMDA/PDA=50/40/60/50).

By using this solution, a polyimide film having a thickness of 10 μm, an adhesive sheet having a thickness of 14 μm, and an FCCL were obtained in the same manner as in Example 1. Their properties are shown in Table 2.

### Comparative Example 2

A polyimide film, an adhesive sheet, and an FCCL were obtained in exactly the same manner as in Example 1 except that random polymerization was performed at a molar ratio of PDA/ODA/BPDA (3,3′,4,4′-biphenyl tetracarboxylic acid dianhydride)/PMDA=20/80/25/75. Their properties are shown in Table 2.

TABLE 1

| | | | | | Comparative | |
|---|---|---|---|---|---|---|
| | Example 1 | | Example 2 | | Example 1 | |
| Prescription for | BAPP | 32 | BAPP | 40 | BAPP | 50 |
| Polymerization | 3,4′-ODA | 18 | BTDA | 15 | BTDA | 40 |
| (Molar Ratio) | BTDA | 22 | PMDA | 21 | PMDA | 5 |
| | PMDA | 23 | PDA | 60 | PDA | 50 |
| | PDA | 50 | PMDA | 64 | PMDA | 55 |
| | PMDA | 55 | | | | |

TABLE 2

| | | | Example 1 | Example 2 | Comparative Example 1 | Comparative Example 2 |
|---|---|---|---|---|---|---|
| Insulating layer | E′ (250° C.), GPa | | 4.7 | 5.0 | 4.3 | 3.2 |
| | E′ (380° C.), GPa | | 1.0 | 1.4 | 0.4 | 0.2 |
| | E′ (380° C.)/E′ (250° C.) | | 0.21 | 0.28 | 0.09 | 0.06 |
| Adhesive sheet | Deviation from flatness, mm | | 4 | 7 | 11 | 13 |
| FCCL | Appearance | | Very good | Very good | Poor | Poor |
| | Fluctuation in rate of | MD | 0.01 | 0.02 | 0.06 | 0.08 |
| | dimensional change, % | TD | 0.01 | 0.01 | 0.02 | 0.01 |

### INDUSTRIAL APPLICABILITY

As described above, an adhesive sheet of the present invention is a heat-resistant adhesive sheet that suppresses fluctuation in rate of dimensional change, and therefore is effective in productively manufacturing flexible circuit boards and the like.

1. A heat-resistant adhesive sheet having a heat-resistant adhesive layer, containing a thermoplastic polyimide, which is provided on at least one surface of an insulating layer containing a non-thermoplastic polyimide, the heat-resistant adhesive sheet having a stretching of not more than 10 mm at one side thereof.

2. The heat-resistant adhesive sheet as set forth in claim 1, wherein the insulating layer has a ratio [E′(380° C.)/E′(250° C.)] of not more than 0.4 between storage moduli of elasticity at 250° C. and 380° C., and has a storage modulus of elasticity at 380° C. of not less than 0.7 GPa.

3. The heat-resistant adhesive sheet as set forth in claim 1, wherein the insulating layer has a storage modulus of elasticity at 380° C. of not more than 2 GPa.

4. The heat-resistant adhesive sheet as set forth in claim 1, wherein the non-thermoplastic polyimide contained in the insulating layer occupies not less than 50 wt % of the entire insulating layer.

5. The heat-resistant adhesive sheet as set forth in claim 1, wherein the thermoplastic polyimide contained in the heat-resistant adhesive layer occupies not less than 70 wt % of the entire heat-resistant adhesive layer.

6. A heat-resistant adhesive sheet to be continuously laminated onto metal foil by heat roller lamination at a temperature of not less than 350° C., the heat-resistant adhesive sheet having a stretching of not more than 10 mm at one side thereof.

7. The heat-resistant adhesive sheet as set forth in claim 2, wherein the insulating layer has a storage modulus of elasticity at 380° C. of not more than 2 GPa.
